(19) United States
(12) Patent Application Publication
(10) Pub. No.: US 2015/0158195 A1
(43) Pub. Date: Jun. 11, 2015

(54) Apparatus for Slicing Food Products

(71) Applicant: Idea S.r.l., Soncino (IT)

(72) Inventors: Mauro Ferrari, Soncino (IT); Dario Gualini, Soresina (IT); Pietro Tomasoni, Borgo San Giacomo (IT)

(73) Assignee: Idea S.r.I., Soncino (IT)

(21) Appl. No.: 14/399,066

(22) PCT Filed: Apr. 10, 2013
(86) PCT No.: PCT/IB2013/052851

§ 371 Date: Nov. 5, 2014

(30) Foreign Application Priority Data
May 10, 2012 (IT) MO2012A000123

(51) Int. Cl. B26D 1/147; B26D 7/01

(52) U.S. Cl. CPC B26D 1/1475; B26D 7/018

(57) ABSTRACT

An apparatus for slicing food products includes a container for the food product and a movable carriage carrying the container and product towards a cutting plane defined by a rotating blade. After slicing, the container can be removed from the carriage and then vacuum sealed for preserving the remaining unsliced product.

### BACKGROUND OF THE INVENTION

The invention relates to an apparatus and a method for slicing, particularly for slicing food products, such as, for example cold cuts, cheeses, and the like.

Specifically, but not exclusively, the apparatus can be usefully employed as an electrical appliance and/or as a professional tool, for example, in a food store or in a restaurant kitchen. Particularly, reference is made to an apparatus according to the preamble of the first claim. Such an apparatus is known, for example, from the patent publications EP 1258325 and EP 1917127.

In the known slicers it is typical that, after cutting the desired slices, an uncut piece of food product remains, which shall be removed from the slicer, then put away in a suitable place, even for a long period of time, during which the left piece of food product shall be appropriately stored.

### SUMMARY OF THE INVENTION

An object of the invention is to produce an apparatus for slicing and for preserving in a proper manner the piece of food product left after slicing.

An object of the invention is to produce an apparatus by means of which it is possible to slice a product in a manner that is safe for the user.

An advantage is to ensure a very efficient and long-lasting conservation of the product piece left after slicing. An advantage is to provide a slicing apparatus that can be used in a simple and convenient manner.

An advantage is to provide a slicing apparatus constructively simple and inexpensive. An advantage is to slice the product in a convenient manner.

An object of the invention is to produce a method for slicing and preserving in a proper manner the piece of food product left after slicing.

Such objects and advantages, and still other ones, are all achieved by the slicing apparatus and method according to one or more of the claims set forth below.

In an example, a slicing apparatus comprises a container carried by a mobile carriage supplying the product, enclosed in the container, towards a cutting plane defined by a rotating blade; after slicing, the container can be removed from the carriage and vacuum sealed for the conservation of the food product.

In an example, a slicing apparatus comprises: a blade arranged to define a non-vertical (horizontal) cutting plane; a supplying device for supplying a product to be sliced through said cutting plane with a supplying movement substantially parallel to said cutting plane; and a support structure that can be rested on a surface and having a shelf part projecting in a cantilevered manner, said supplying device being movable at least partially above said shelf part, said blade being arranged in the proximity of said shelf part so that a cut slice of product falls below said shelf part.

### BRIEF DESCRIPTION OF THE DRAWINGS

The invention will be better understood and implemented with reference to the appended drawings, which illustrate a non-limiting implementation example thereof.

FIG. 1 is a perspective view of an example of apparatus implemented according to the invention.

FIG. 2 is a plane top view of the apparatus of FIG. 1.

FIG. 3 is the view of FIG. 2 in which some details inside the apparatus are visible.

FIG. 4 is the section IV-IV of FIG. 3.

FIG. 5 is the section V-V of FIG. 3.

FIG. 6 is the section VI-VI of FIG. 3.

FIG. 7 is the section VII-VII of FIG. 3.

FIG. 8 is the section of FIG. 3.

FIG. 9 is a section of the removable container used in the apparatus of the preceding figures.

FIG. 10 is a perspective view of a second example of a slicing apparatus, implemented according to the invention.

FIG. 11 is a section of the apparatus of FIG. 10 carried out according to a vertical section plane.

FIG. 12 is a view of the apparatus of FIG. 10, in another perspective, with some parts removed to better illustrate other ones.

FIG. 13 is a view of the apparatus of FIG. 10, in still another perspective, with some parts removed to better illustrate other ones.

FIG. 14 shows an enlarged detail of FIG. 11, in which the product cutting zone can be seen.

FIG. 15 is a top view of the apparatus of FIG. 10.

FIGS. 16 and 17 are the sections XVI-XVI and XVII-XVII of FIG. 15.

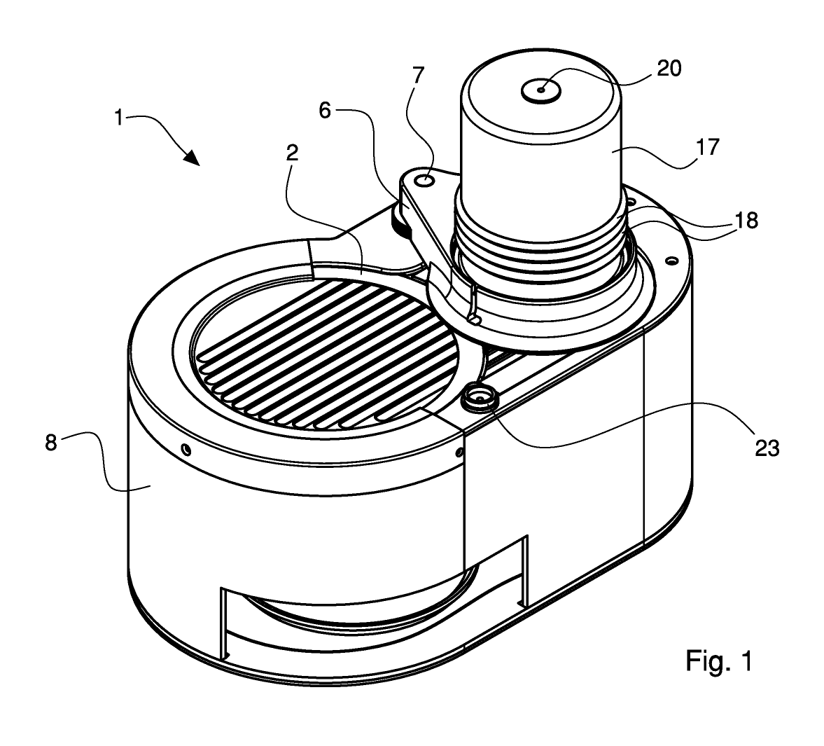

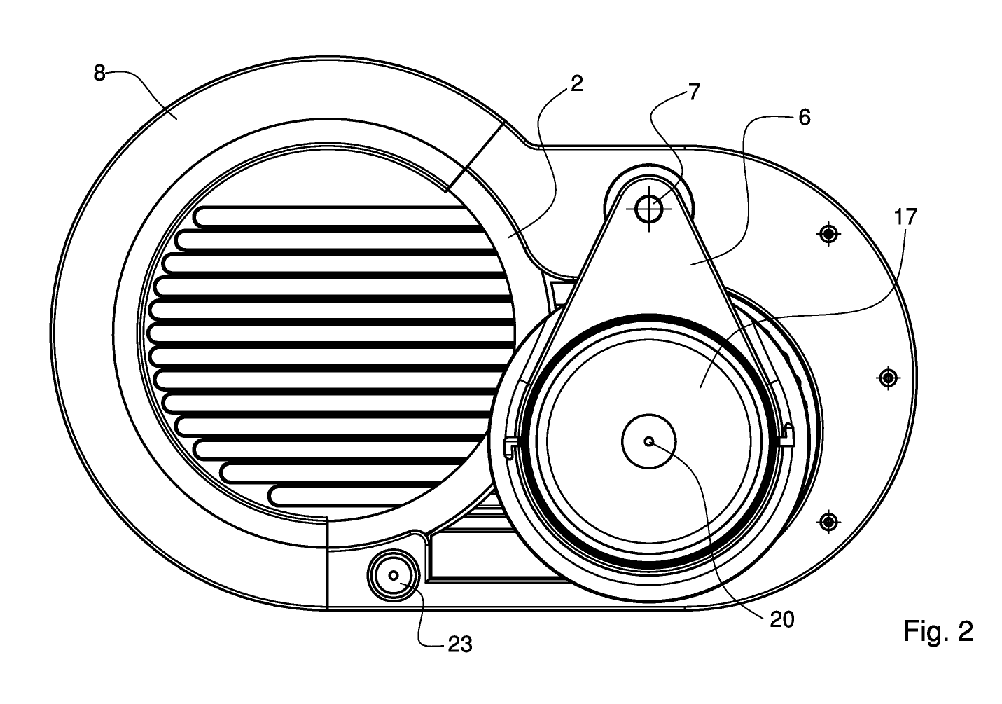

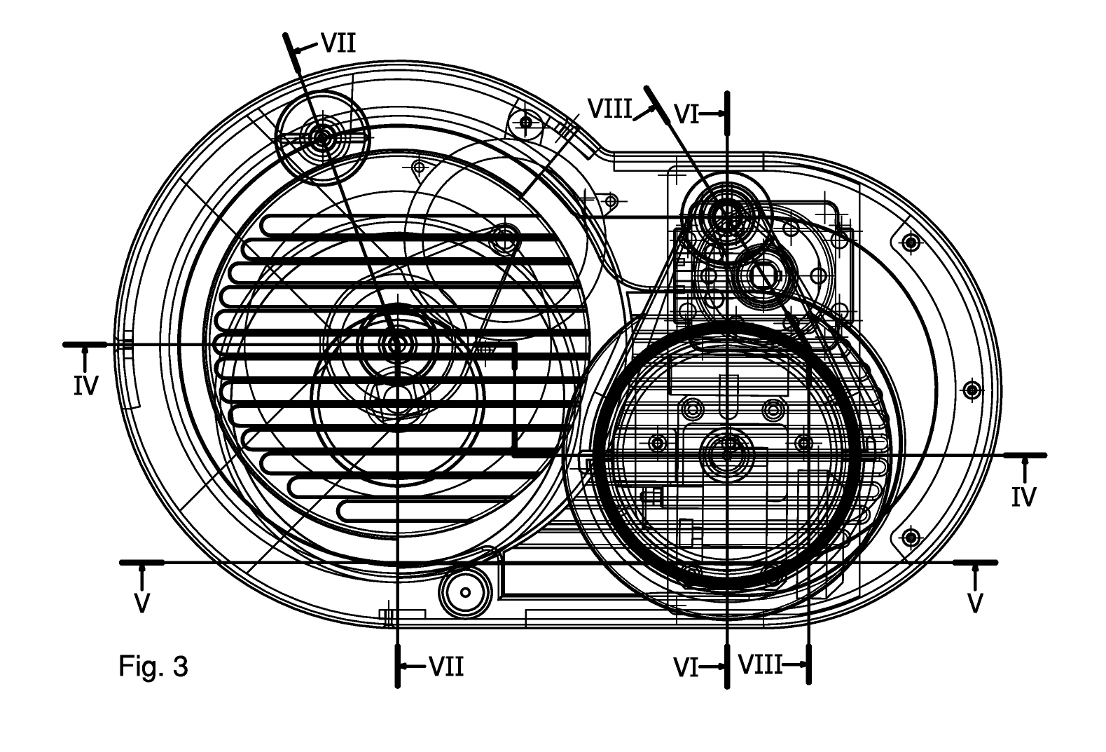

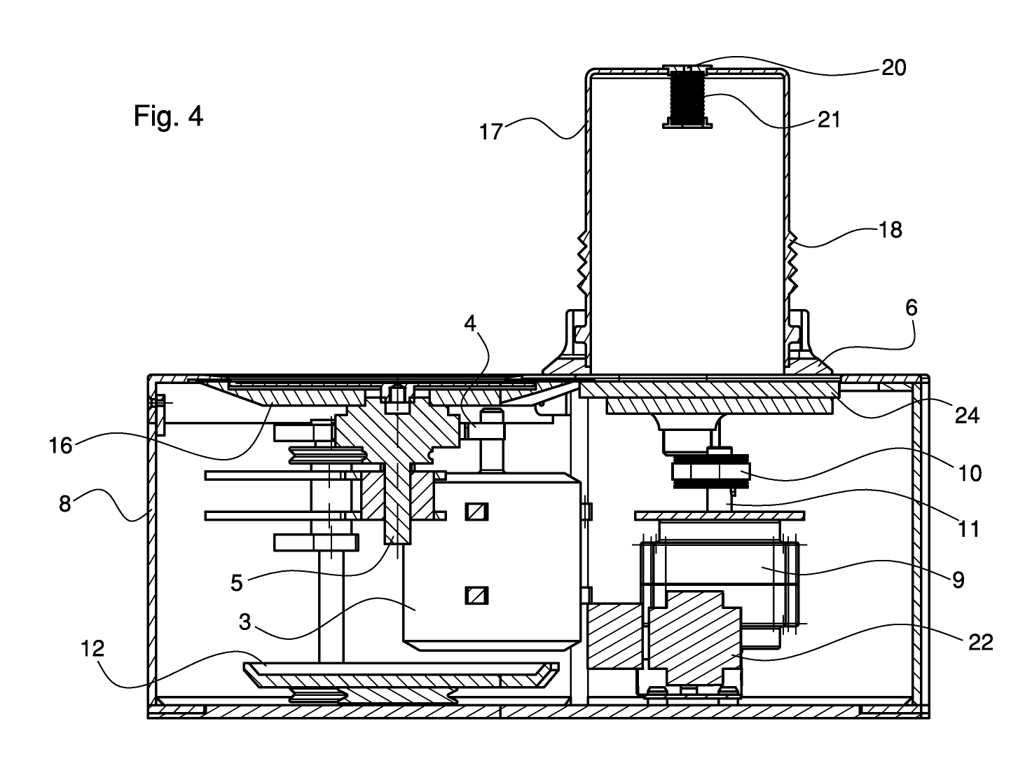

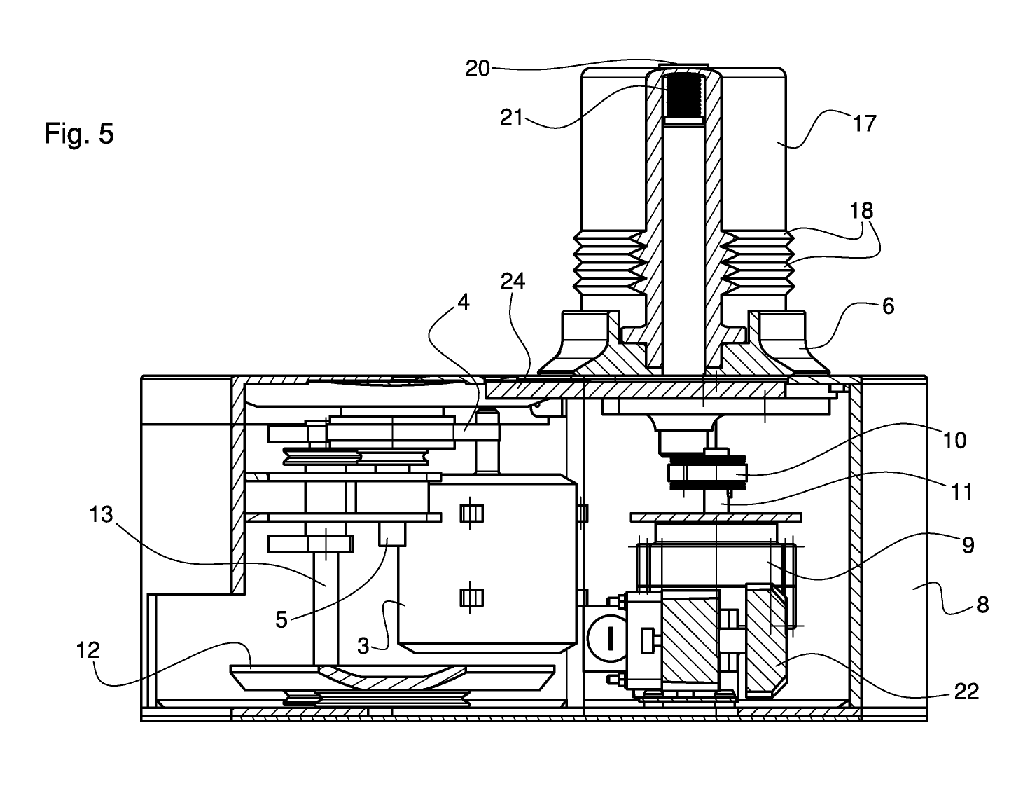

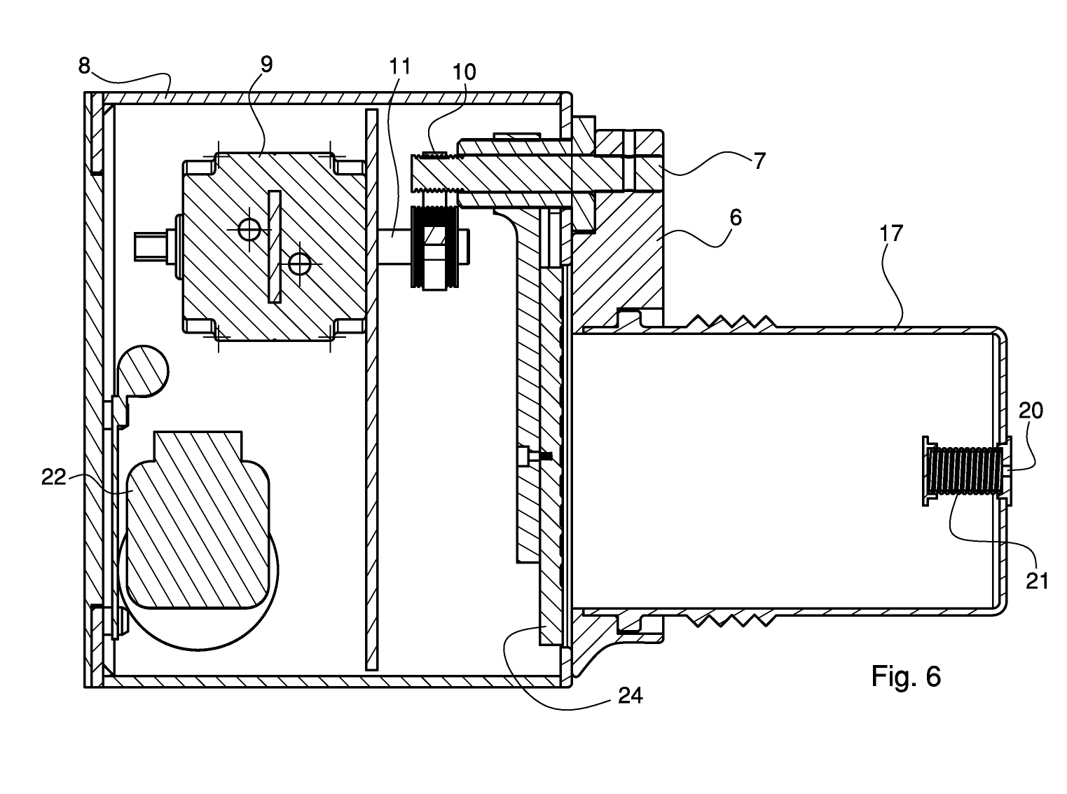

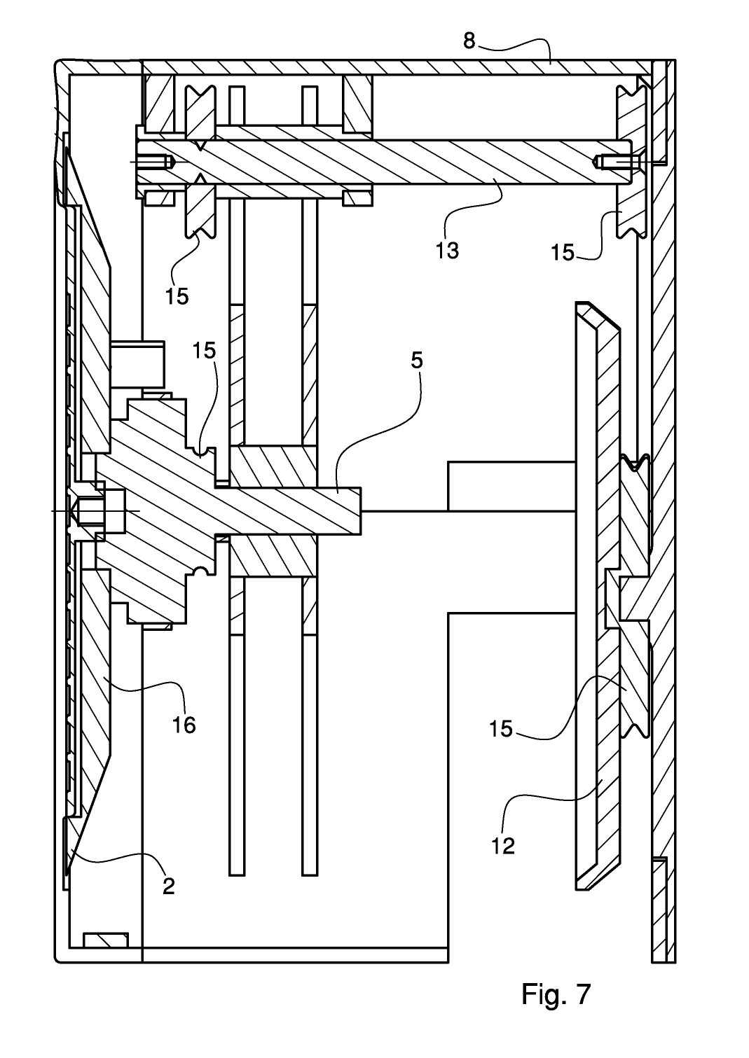

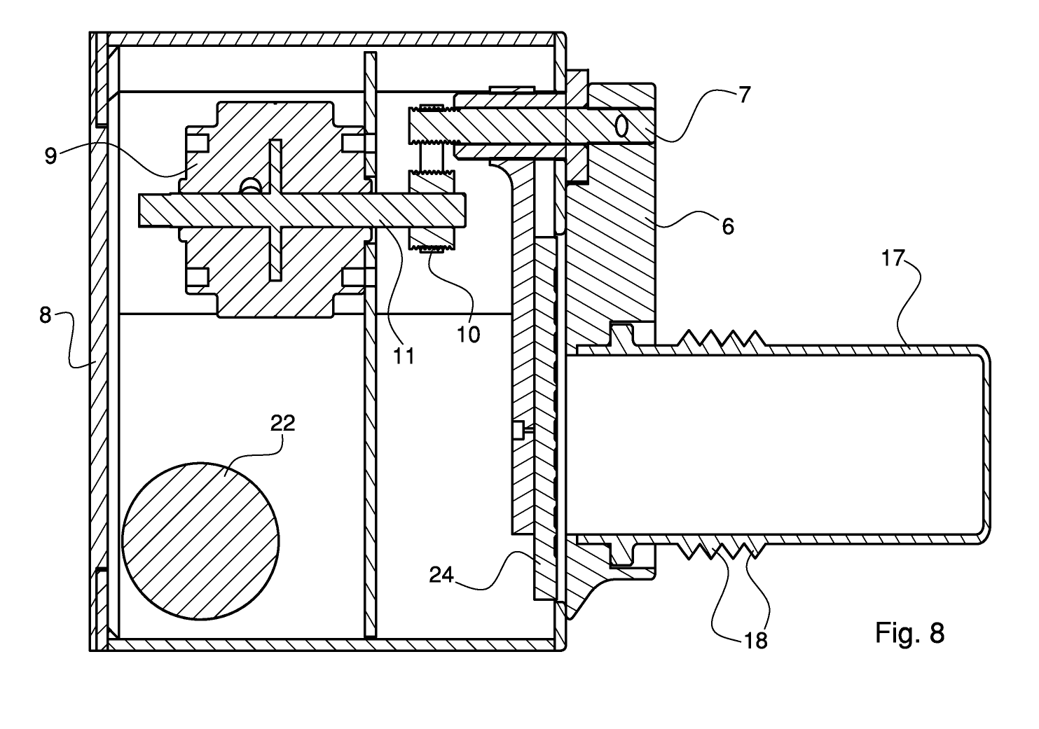

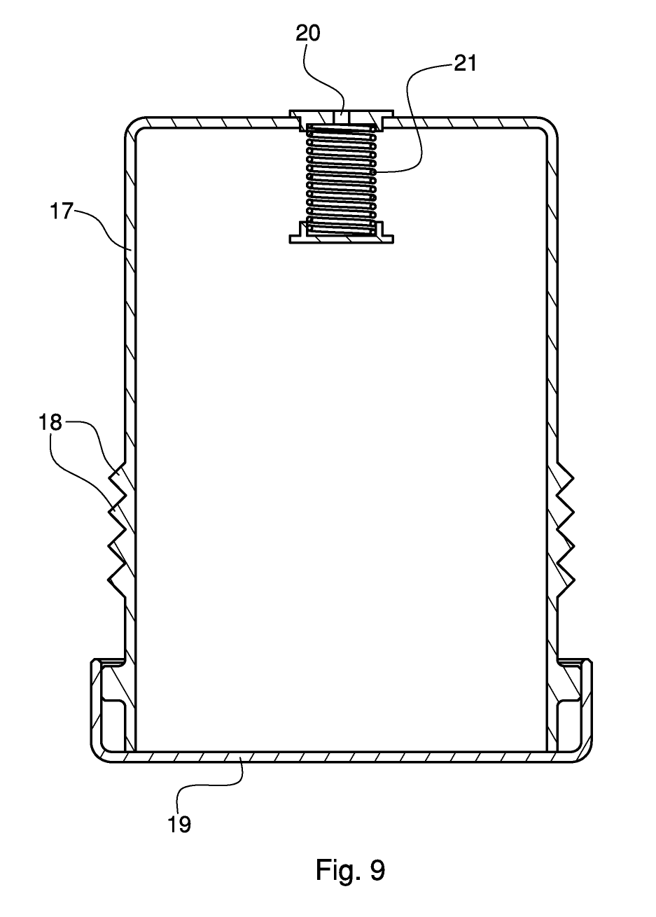

### DETAILED DESCRIPTION

With reference to the above-mentioned figures, a slicing apparatus has been generally indicated with 1, particularly for slicing food products, such as, for example, cold cuts, cheeses and similar products. The apparatus 1 comprises a blade 2 for slicing the food product, rotationally actuatable and arranged to define a cutting plane. A blade motor 3 rotates (particularly through at least one flexible traction member, for example, a belt 4) a blade supporting shaft 5 on which the blade 3 is mounted.

The apparatus 1 comprises a supplying device for supplying the food product to be sliced towards the blade 2 and through the cutting plane. The supplying device comprises, particularly, a mobile carriage 6 with the possibility to perform a reciprocating movement with a forward stroke and a return stroke. In the forward stroke, the food product passes through the cutting plane so as to separate a slice of product, while, in the return stroke, the food product comes back to start again a new cutting cycle, therefore to form the successive slice.

The reciprocating movement of the carriage 6 may be, as in this case, an oscillation about a rotational axis 7 (perpendicular to the cutting plane). In other, non-illustrated examples, the carriage may be able to translate back and forth along a linear direction. The swinging carriage 6 is, in this case, rotatably mounted on a casing 8 of the apparatus about the rotational axis 7. Furthermore, the supplying device may be able to comprise, as in the example described herein, a carriage motor 9 to actuate the alternated movement of the carriage 6. In other, non-illustrated examples, the carriage motion may be able to be manually provided by the operator. The carriage motor 9 may be able to be, as in this case, connected to the swinging carriage 6 through motion transmission means (for example, flexible traction means comprising, particularly, at least one transmission belt 10) arranged to transmit the rotational motion from a motor shaft 11 of the carriage motor 9 to the rotational axis 7 of the swinging carriage 6.

The casing 8 forms a containment structure holding at least the blade motor 3 and the carriage motor 9. The casing 8 may be able to further contain mechanical flywheel means connected to the blade supporting shaft 5. The flywheel means may comprise, as in this case, a lower rotating plate 12—which may be particularly connected to the blade supporting shaft 5 by a transmission shaft 13 and motion transmission means that, in the specific example, comprises belts wound on pulleys 15—and/or an upper rotating plate 16 connected (for example, coaxial and integral) to the blade supporting shaft 5.

The apparatus 1 comprises a container 17 removably applied to the supplying device (particularly, to the carriage 6) to contain the food product while this is sliced. Particularly, an end of the container 17 may be able to be inserted and removed (for example, in an axial insertion direction) in a seat of the mobile carriage 6. The container 17 may be inserted and removed from the seat arranged on the carriage manually by the operator. The container 17 may be coupled to the seat of carriage 6 by a quick coupling joint, for example, a coupling of the bayonet type, as in the specific case.

The container 17 may comprise a side wall (tubular-shaped, for example, cylindrical) closed at a first end by a bottom wall and open at a second end opposite the first one. Such an opening will allow the food product to be accessed by the cutting means during the slicing operation. The side wall of the container 17 may have, externally, gripping means to promote the manual grip by an operator. Such gripping means may comprise, for example, a series of reliefs 18, for example, circumferential reliefs. The container 17 comprises removable closure means (comprising, for example, at least one lid 19 that is pressurized, or screwable, or of another type) to seal the container itself, once it has been removed from the apparatus, and to vacuum hold the food product. Both the container 17 and the lid 19 may be able to be made in food grade plastic.

The closure means of the container may comprise, as in the specific case, an orifice 20 provided with a vacuum valve. The orifice 20 is arranged on the closed first end of the container, opposite the second end having the opening. The container 17 is provided with elastic means arranged to push the food product (located inside the container) towards the cutting plane. Such elastic means (for example, a coil spring 21) may be arranged on the bottom wall closing the container first end, for example, at the vacuum valve in the orifice 20.

The apparatus 1 comprises suction means to suck air from the container 17 so as to vacuum preserve the food product left. In the specific case, the suction means comprises a vacuum pump 22 (particularly a gas transfer pump, such as, for example, a swinging piston pump or another type).

In this case, the suction means (pump 22) is contained inside the casing 8. The latter has externally, particularly, a port or opening 23 connected to the suction means and removably couplable to the orifice 20 of the container. The port or opening 23 for accessing the suction means will be provided, particularly, with an air valve that is normally closed. It shall be apparent that the apparatus will be provided with command means (for example, keys, buttons, or other means of a known type) to actuate the various actuators, particularly the blade motor 3, the carriage motor 6, and the vacuum pump 22.

In use, during the slicing operation, the container 17 is applied to the swinging carriage 6 so as to enclose the food product therein. The elastic means (spring 21) provides to push the product in order to keep it against a reference plane that can be defined, for example, by a movable adjustment plate 24, the position of which can be set to vary the slice thickness. At the end of the slicing operation, the container 17 is removed from the apparatus (for example, by disengaging the bayonet coupling, or axially withdrawing the container from the seat on the carriage 6), as well as the portion of food product left unsliced. The container 17, with the piece of product left therein, will be closed by the lid 19, and then a vacuum will be created by connecting the orifice 20 of the container (where the vacuum valve is arranged) to the access port or opening 23 connected to the suction means. The connection may be able to take place by simply positioning the orifice 20 at the opening 23. The vacuum pump 22 will be actuated for the time necessary to put the container 17 under vacuum. The left product can thus be conserved under vacuum in the container 17 until the next slicing operation.

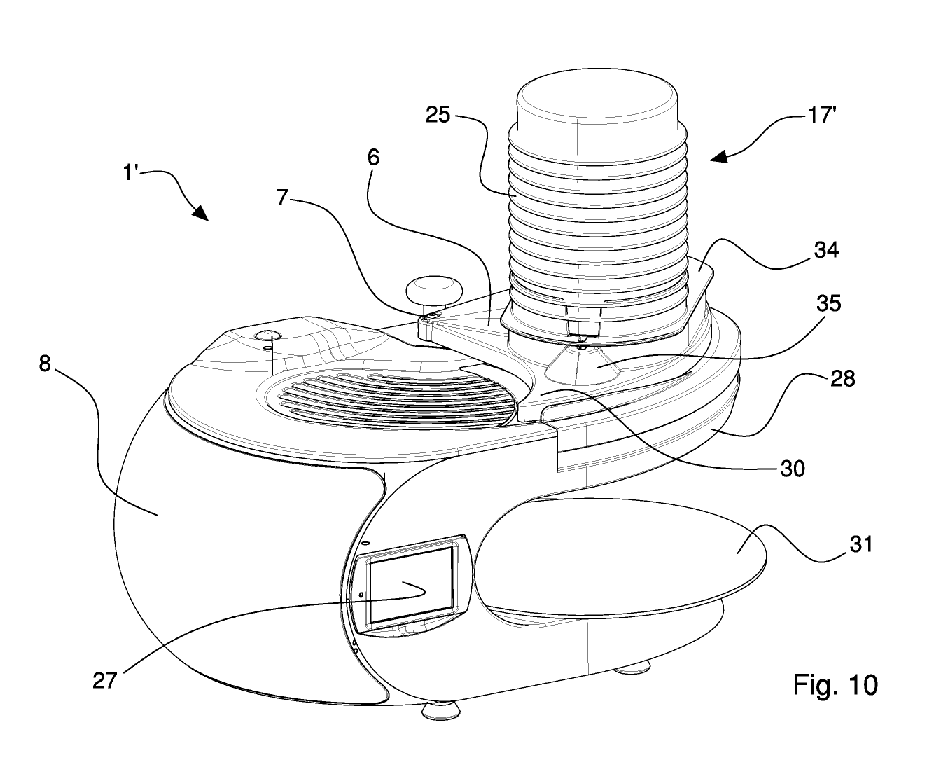

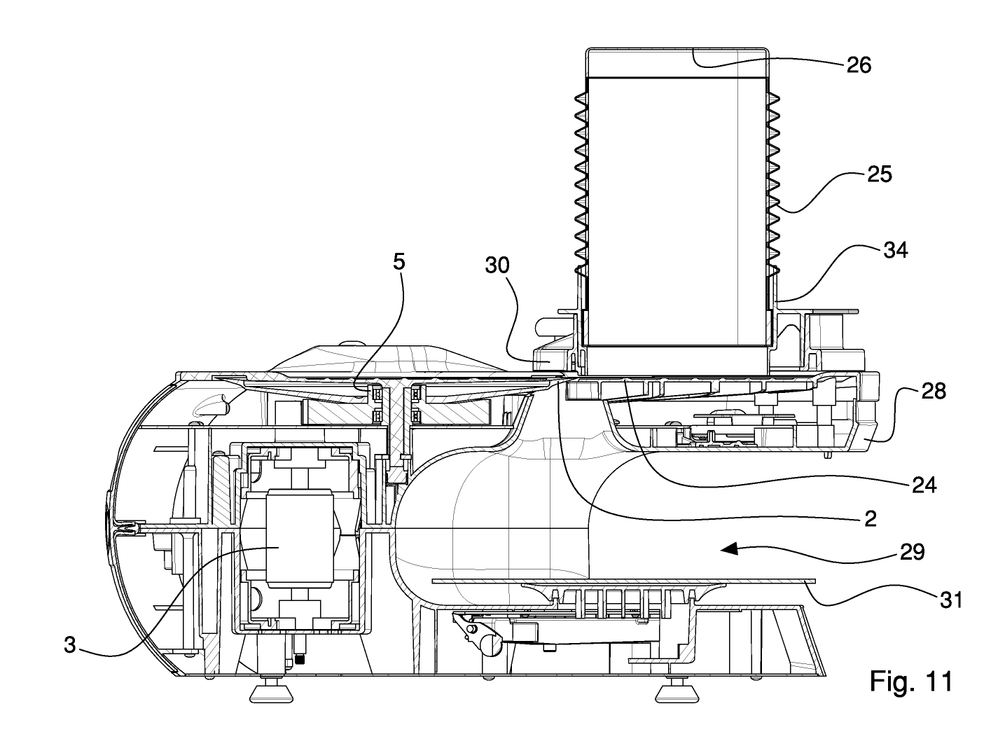

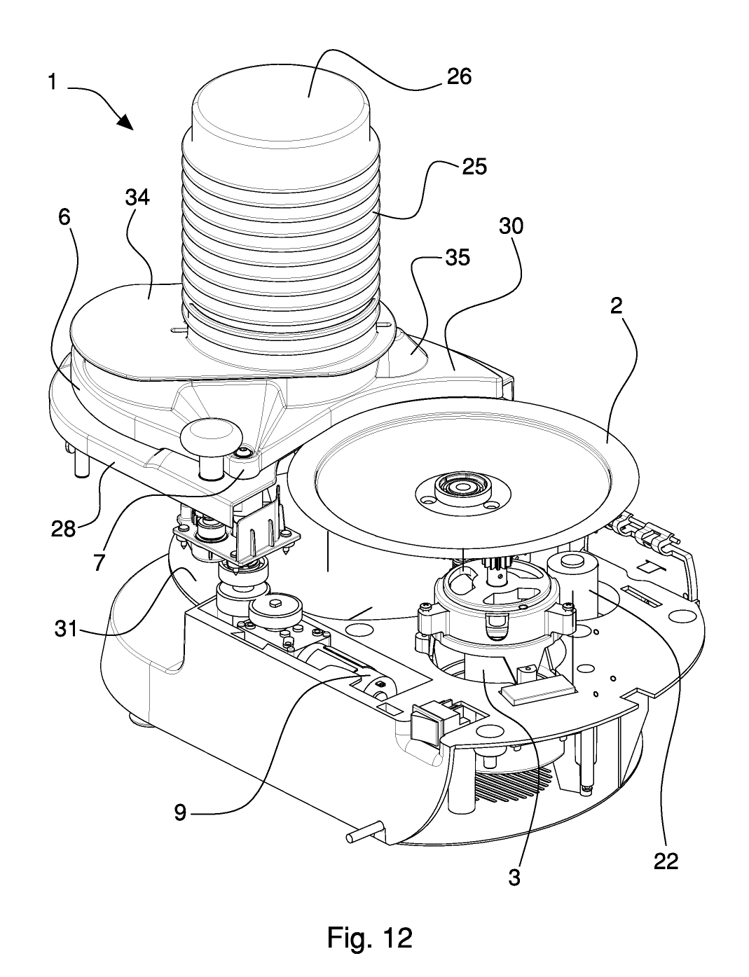

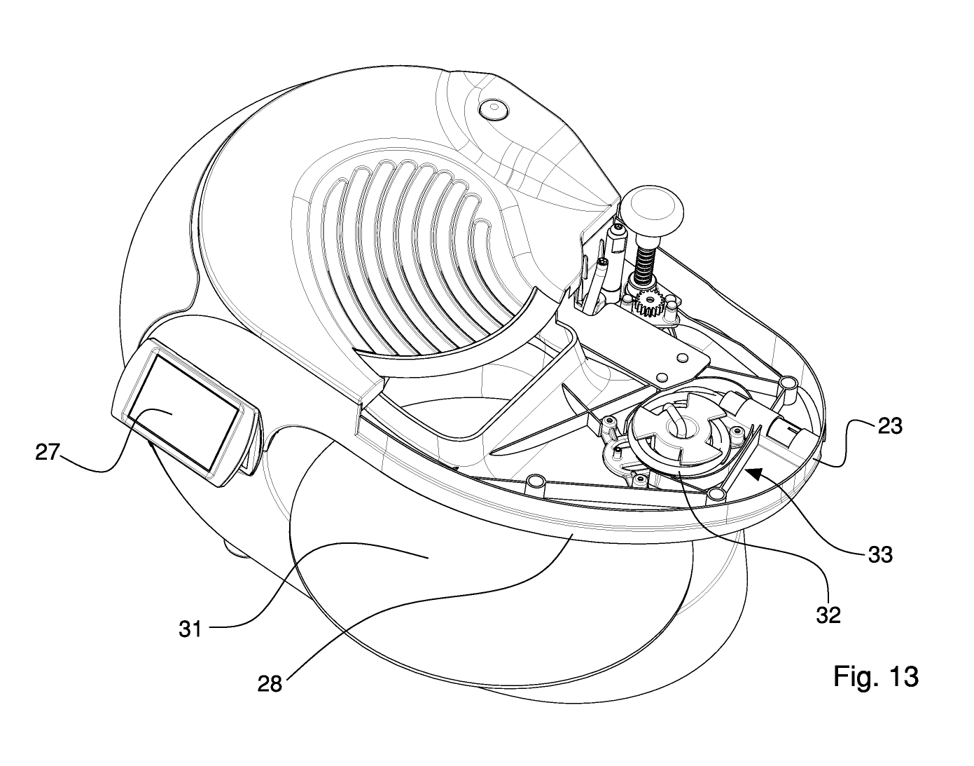

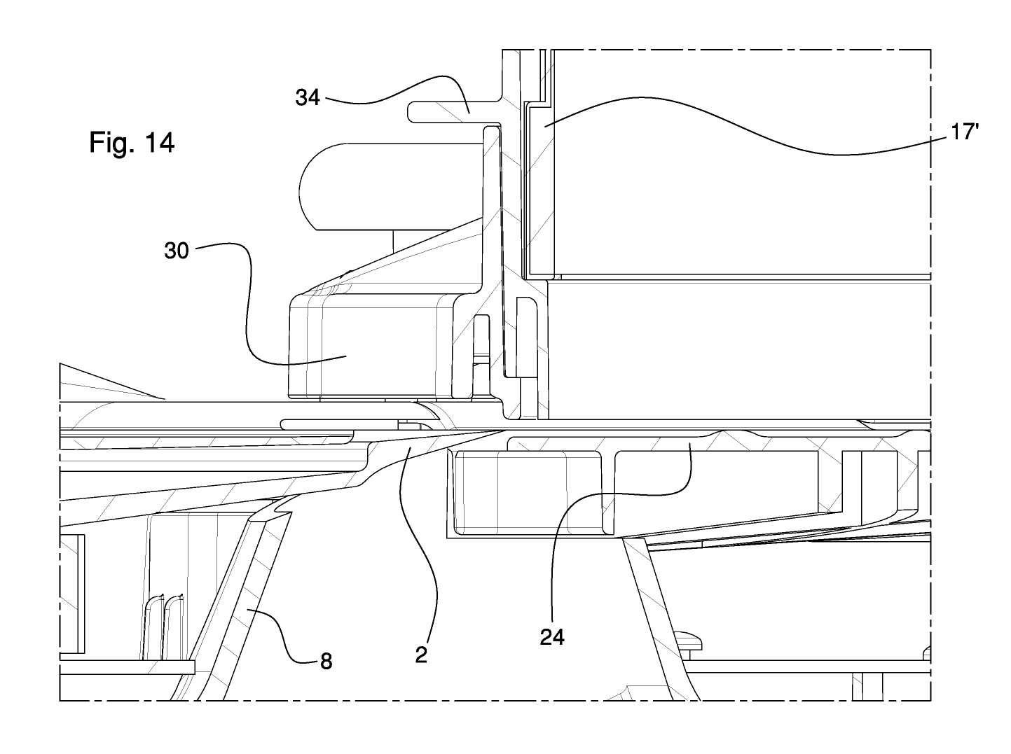

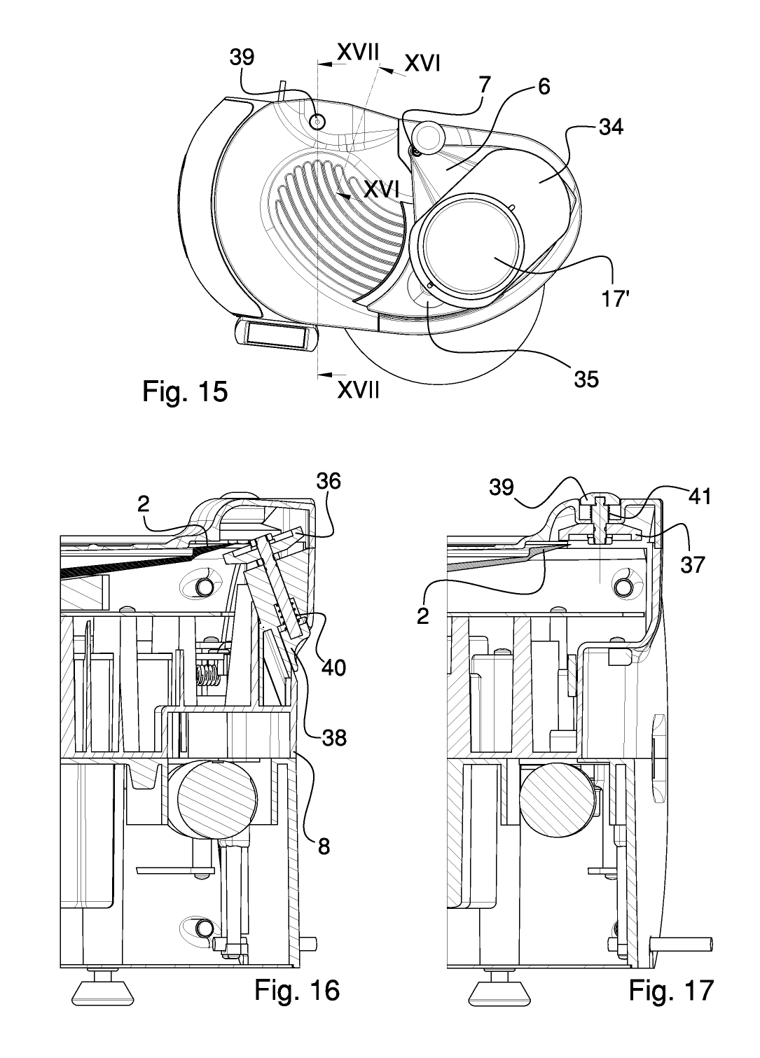

Referring now to the FIGS. 10 to 17, a slicing apparatus has been generally indicated with 1′, particularly for slicing a (food) product in accordance with a second embodiment of the invention. For a better presentation clarity, those elements of the apparatus 1′ that are similar to those of the apparatus 1 described before have been indicated with the same numbering.

Particularly, the apparatus 1′ will be able to comprise also a blade 2 to slice the food product, rotationally actuatable and arranged to define a cutting plane (horizontal or anyhow non-vertical, and therefore having at least one non-null orthogonal projection on a horizontal plane). The apparatus 1′ may have a blade motor 3 that rotates a blade supporting shaft 5 on which the blade 2 is mounted. The apparatus 1 may also comprise a supplying device for supplying the food product to be sliced towards the blade 2 and through the cutting plane. The supplying device may comprise, in this example too, a mobile carriage 6 with the possibility to perform an alternated movement with a forward stroke and a return stroke. The carriage 6 alternated movement may be, particularly, a swinging movement about a rotational axis 7 (perpendicular to the cutting plane). The swinging carriage 6 is, in this case too, rotatably mounted on an apparatus casing 8 about the rotational axis 7. The supplying device will be able to further comprise, in this example also, a carriage motor 9 to actuate the alternated movement of the carriage 6. The carriage motor 9 will be able to be, in this case too, connected to the swinging carriage 6 through motion transmission means arranged to transmit the rotational motion from the carriage motor 9 to the swinging carriage 6.

The motion transmission means may comprise, for example, a device (also of a known type) to convert a continuous rotational motion into a alternated rotational motion: it will be possible to use a cam-type transmission mechanism (with a cam and a rocker arm), or of the four-bar linkage type (with crank and rocker), or of the Maltese cross type, etc. Anyhow, such a device may comprise any other type of mechanism suitable to convert a continuous rotational motion (of the motor shaft of the product supplying motor 9) into an alternated rotational motion (of the supplying device about the axis 7).

The apparatus 1′ may comprise a container 17′ removably applied to the supplying device (particularly, to the carriage 6) to hold the food product while this is sliced. An (open) end of the container 17′ will be able to be inserted and removed in a seat of the movable carriage 6. Such an end of the container 17′ will be, particularly, arranged inferiorly when the container is in the insertion position. The container 17′ may be inserted and removed from the seat arranged on the carriage 6 manually by the user.

The apparatus 1′ may comprise (motorized) suction means to suck air from the container 17′ so as to preserve the food product left in the container 17′ under vacuum. Such suction means may comprise a vacuum pump 22 or other means for generating a food vacuum (of a known type).

The container 17′ may comprise a side wall 25 (tubular-shaped) closed at a first end by a bottom wall 26 and having the above-mentioned opening (that can be closed again after the removal of the container 17′) at a second end opposite the first one. Such an opening will allow the food product to be accessible to the cutting means during the slicing operation. The side wall 25 of the container 17′ may comprise, as in this example, a flexible wall, for example a wall that can be folded (bellows-like).

The container 17′ may comprise removable closure means (comprising, for example, at least one pressurized lid, or screwable, or of another type, not illustrated) to seal the above-mentioned container opening, once it has been removed from the apparatus, and to be thus able to hold the food product under vacuum. In the case of the container 17′, the closure means of the container may be provided with an orifice (provided with a vacuum valve) to connect the inside of the container 17′ with the suction means to generate the vacuum.

The apparatus 1′ will be provided with command means (for example, keys, buttons, or other means of a known type) to actuate the various actuators, particularly, the blade motor 3, the carriage motor 6, and the vacuum pump 22. In the specific case, the apparatus 1′ comprises a graphic user interface provided with a touch screen 27.

In the slicing apparatus of the FIGS. 10 to 17, the support structure carrying the blade 2 and the supplying device (particularly, the carriage 6 and, when applied, the removable container 17′) has a shelf part 28 projecting in a cantilevered manner from a base part (provided with resting feet) that can be rested to an outer surface, and may be at least partially arranged at the height of the cutting plane defined by the blade 2. The supplying device, particularly the (swinging) carriage 6 and the container 17′ of the product to be sliced, will be at least partially arranged at the height of and/or above the shelf part 28 of the support structure. In this manner, the product to be sliced will be able to be arranged above the cutting plane. The blade 2 and the supplying device will be have a mutual arrangement so that a cut slice of product will be intended to fall below the shelf part 28 in a zone 29 for receiving the slice.

Particularly, the removable container 17′ may be carried by the supplying device in an operative position in which the container 17′ itself is arranged above the shelf part 28 and/or above the cutting plane.

The opening of the container 17′, through which the food product can access the cutting plane to be sliced, will face downwards.

The supplying device mobile may be provided, as in the case illustrated herein, with a protection wall 30 (integrally movable with the device itself) arranged above the shelf part 28 and extending to cover a cutting zone in which the product is sliced by the blade 2. Such a protection wall 30 (integrally movable with the carriage 6) may cover the cutting zone for each position taken by the supplying device during the (alternated) movement for supplying the product. Particularly, the protection wall 30 will be integral with the mobile carriage 6 with an alternated motion. Furthermore, the casing 8 may be provided, as in this case, with a fixed protection wall arranged above the blade 2 and substantially parallel to the cutting plane.

The slicing apparatus may comprise, as in this example, a bottom part 31 (secured to the support structure) arranged below the shelf part 28 to define the reception zone 29 of the cut slice. The bottom part 31 will be able to be arranged at a vertical distance from the shelf part 28 so that a void space is identified, in which the cut slice coming from the cutting zone at the cutting plane can fall on the bottom part 31. It is possible to provide that the bottom part 31 (for example, in the shape of a plate) is provided with means for weighing the sliced product (and its possible tare). Such weighing means may comprise, for example, an (electronic) scale arranged below the bottom part 31.

The control means for the actuation of the actuation motor means for the blade 2 may comprise programmable electronic control means. Such control means may be connected to sensor means 35 arranged to signal the control means when the container 17′ is removed from the supplying device. Such sensor means 35 may comprise, for example, presence sensor means arranged to detect the presence of the container in a predetermined fitting or coupling position with the supplying device. Such sensor means 35 may comprise, for example, an optical sensor and/or an electric switch and/or other presence/absence sensor means (also of a known type).

In order to ensure the user's safety, the control means may be programmed to provide a consent to actuate the blade actuation motor means only when the container is located in the above-mentioned fitting or coupling position with the supplying device.

In this position, the same container will be able to be arranged so as to perform a function of protection and safety, being capable of covering the (underlying) cutting zone so as to prevent the user from (dangerously) approaching the cutting zone. In fact, while the product located in the container will be able to access the cutting zone through the lower opening, the user will be protected against accidental contacts with the moving blade, being protected by the supplying device itself.

The apparatus control means may comprise means to allow the user (for example, by the user interface, particularly, through the touch screen 27) selecting one or more desired values of one or more operative parameters, such as, for example, the number of slices to be cut and/or the weight of the product to be sliced. The control means may comprise means for displaying on a screen (for example, on the touch screen 27) the current value of one or more operative parameters (for example, the weight of the sliced product) as the product is sliced, so that the user can have a constant vision of the ongoing variation of the parameter.

The slicing apparatus 1′ particularly comprises a flexible tube 32 connecting the suction means (vacuum pump 22) with the opening 23 arranged outside the casing 8. The flexible tube 32 is susceptible to be pulled outside the casing 8 through the opening 23 to facilitate the connection with the removed container 17′ and therefore the possibility to generate the vacuum outside the container itself. The opening 23 may be arranged outside the shelf part 28.

The apparatus 1′ may comprise a winding device 33 with elastic return to allow the flexible tube 32 elastically returning inside the casing 8. The flexible tube 32, in a return configuration, will be wrapped in the winding device 33 about a winding axis. The winding device 33 may be arranged inside the shelf part 28.

As in the specific case described herein, the removable container 17′ may have at least one movable wall to define a space with a variable volume for the containment of the product. While in the case of the container 17, the variable volume was substantially generated by means of the spring 21 (i.e., by an at least partially elastically movable bottom wall), the container 17′ comprises a flexible (foldable) side wall 25 for the lateral containment of the product. The flexibility of the side wall, with the possibility to fold upon itself or to collapse, allows varying the product containment volume. Such a side wall 25 is foldable so as to allow an (axial) movement of the bottom wall 26 so as to vary the product containment volume. Such a side wall 25 may comprise a foldable bellows-like wall. Particularly, such a flexible side wall 25 comprises a fluid sealing wall.

The container 17′ may be applied to the swinging carriage 6 so as to enclose the food product therein. The user will be able to push the product, due to the variable volume container 17′ flexibility, in order to keep it in contact against a reference plane that can be defined, for example, by the mobile adjustment plate 24, the position of which can be set to vary the slice thickness. At the end of the slicing operation, the container 17′ will be able to be removed from the apparatus 1′, together with the portion of food product left unsliced. The container 17′, with the left piece of product therein, will be closed by its own closure means (removable lid), and then the vacuum will be created by connecting the container 17′ (in this particular case, through the orifice arranged on the closure means of the container 17′ and the flexible tube 32) to the suction means inside the apparatus F. The fluid connection will be able to take place by simply pulling the flexible tube 32 and putting it in communication (through the orifice provided with valve arranged on the closure means) with the inside of the container 17′. The vacuum pump 22 will be actuated for the time necessary to put the container 17′ under vacuum.

In the specific case described herein, the container 17′ may be coupled (removably) to the seat arranged on the supplying device (carriage 6) by an adapter 34. Thus, it is possible to use at least another container, or more than one, with dimensions different from the container 17′. Essentially, it is possible to provide a kit of containers having different shapes and dimensions, each being suitable to hold a specific product. Each container will be able to be associated to the seat on the supplying device by a suitable adapter. Furthermore, it is possible that a container of the kit is directly couplable on the seat without using any adapters.

The slicing apparatus may comprise, for example, a grinding device, for example, integrated in the apparatus 1′ (particularly, contained inside the casing 8), to sharpen the blade 2. The grinding device may comprise, as in this example, a first grinding member 36, arranged to sharpen a first side of the blade 2, and a second grinding member 37, arranged to sharpen a second side, opposite the first one, of the blade. Each of the first grinding member 36 and the second grinding member 37 may comprise a body, for example, a disc-shaped body, produced in a material suitable to sharpen a blade (a metal blade). The first grinding member 36 (and/or the second grinding member 37) may be movable, with the possibility to take an active position in contact with the blade 2 and an inactive position (as in the FIGS. 16 and 17) spaced apart from the blade 2. The grinding device may comprise a first driving member 38 and/or a second driving member 39 to allow a user displacing, the first grinding member 36 and/or the second grinding member 37, respectively, towards the active position of contact with the blade.

Each of the first and the second driving members 38 and 39 may comprise a button (arranged outside the casing 8 to be accessible to the user), the compression of which involves a thrust of the respective member 38 or 39 towards the active position. The grinding device may comprise first elastic means 40 and/or second elastic means 41 arranged to displace the first grinding member 36 and/or the second grinding member 37, respectively, towards the inactive position (spaced apart from the blade 2). The two members 38 and 39 may be arranged near to each other, and mutually opposite, so that a user can push both of them simultaneously with only one hand.

1-40. (canceled)

41. A slicing apparatus, comprising
a. A rotatable blade that defines a cutting plane;
b. a supplying device for supplying a food product to be sliced through said cutting plane;
c. a removable container connected with said supplying device to contain the food product while it is being sliced; and
d. a closing element for closing and sealing said removed container and for creating a vacuum therein.

42. Apparatus as defined in claim 41, and further comprising a suction device for creating the vacuum within said removed container.

43. Apparatus as defined in claim 42, wherein said suction device comprises vacuum pump.

44. Apparatus as defined in claim 42, wherein said suction device is contained in a casing of said apparatus, said casing having a port connected to said suction device and removably coupled with an orifice of said container, wherein said port has a normally closed air valve, said casing contains a blade motor for rotating said blade, said supplying device comprises a carriage that is movable with reciprocating movement, and said casing contains a carriage motor for driving said carriage.

45. Apparatus as defined in claim 41, wherein said closing element comprises an orifice contained in a wall of said container and provided with a vacuum valve.

46. Apparatus as defined in claim 45, wherein said container comprises an opening to enable the food product to access said cutting plane, said closing element comprising a removable lid for closing and sealing said opening after said container has been removed from said supplying device, said orifice being arranged on a first container end opposite a second container end containing said opening, said container being provided with an elastic element for pushing the food product to said cutting plane, and said elastic element being arranged on said first container end, in particular at said orifice.

47. Apparatus as defined in claim 41, wherein
said cutting plane is horizontal or has at least one non-null orthogonal projection on a horizontal plane;
said supplying device is capable of movement substantially parallel to said cutting plane; and
said apparatus further comprises a support structure to support at least one of said blade and said supplying device, said support structure having a shelf part projecting in a cantilevered manner and at least partially arranged at the height of said cutting plane, said supplying device being arranged at least partially at the height of said shelf part so that the food product to be sliced is arranged above said cutting plane in order that a cut slice of product falls below said shelf part.

48. Apparatus as defined in claim 47, wherein said container is carried by said supplying device in an operative position in which it is arranged above at least one of said shelf part and above said cutting plane, wherein said container comprises an opening to allow the food product to access said cutting plane, said container being carried in said operative position with said opening facing downwards, wherein said supplying device reciprocates back and forth, said supplying device carrying a protection wall that is movable and arranged above said shelf part to cover a cutting zone in which the product is sliced by said blade, said movable protection wall covering said cutting zone for each position taken by said supplying device during said reciprocating movement.

49. Apparatus as defined in claim 47, and further comprising a bottom part connected with said support structure and arranged below said shelf part to define a reception zone for the cut slice, said bottom part being arranged at a vertical distance from said shelf part to define a void so that a cut slice can fall from said cutting plane on said bottom part.

50. Apparatus as defined in claim 41, wherein said removable container has at least one wall that is movable to define a variable volume space to contain the product.

51. Apparatus as defined in claim 50, wherein said container comprises at least one flexible wall for the lateral containment of the product, and wherein said variable volume space to contain the product is defined by one or more fluid sealing walls.

52. Apparatus as defined in claim 41, wherein said supplying device moves substantially parallel to said cutting plane for supplying a product to be sliced through said cutting plane, said apparatus further comprises a grinding device to sharpen said blade.

53. Apparatus as defined in claim 52, wherein said grinding device comprises at least one first grinding member arranged to sharpen at least one first side of said blade, wherein said at least one first grinding member being movable between an active position in contact with said blade and an inactive position spaced apart from said blade, and further wherein said grinding device comprises at least one first driving member to allow a user displacing said at least one first grinding member towards said active position and a first elastic member arranged to displace said at least one first grinding member towards said inactive position.

54. Apparatus as defined in claim 53, wherein said grinding device further comprises at least one second grinding member arranged to sharpen a second side of said blade opposite said first side, said at least one second grinding member being movable between an active position in contact with said blade and an inactive position spaced apart from said blade, at least one second driving member to allow a user to displace said at least one second grinding member towards said active position, and a second elastic member arranged to displace said at least one second grinding member towards said inactive position.

55. A slicing apparatus, comprising
a. a rotatable blade defining a cutting plane;
b. a blade motor for rotating said blade;
c. a supplying device for supplying a food product to be sliced through said cutting plane;
d. a removable container connected with said supplying device to hold the food product while it is sliced;
e. a control device for driving said blade motor arrangement; and
f. a sensor for signaling said control device when said container is removed from said supplying device.

56. Apparatus as defined in claim 55, wherein said sensor comprises a presence sensor, arranged to detect the presence of said container in a predetermined coupling position to said supplying device.

57. Apparatus as defined in claim 55, wherein said supplying device is alternately movable back and forth along a path substantially parallel to said cutting plane for supplying a product to be sliced through said cutting plane, said apparatus further comprising a product supplying motor separate from said blade motor to actuate said alternate movement of said supplying device, and further wherein said back and forth movement comprises swinging about a swinging pin having a rotational axis perpendicular to said cutting plane.

58. A slicing apparatus, comprising
a. a rotatable blade defining a cutting plane;
b. a supplying device for supplying a food product to be sliced through said cutting plane; and
c. a motorized suction device for creating a vacuum in a removable container connected with said supplying device to hold the food product while it is sliced.

59. Apparatus as defined in claim 58, and further comprising a casing that contains said suction device and a flexible tube connecting said suction device with an opening on said casing, said flexible tube extending at least partially outside of said casing through said opening.

60. Apparatus as defined in claim 59, and further comprising a winding device with an elastic return to draw said flexible tube elastically back into said casing.
